(19) United States
(12) Patent Application Publication
(10) Pub. No.: US 2019/0093499 A1
(43) Pub. Date: Mar. 28, 2019

(54) NON-CONTINUOUS ABRADABLE COATINGS

(71) Applicants: Rolls-Royce Corporation, Indianapolis, IN (US); Rolls-Royce North American Technologies, Inc., Indianapolis, IN (US)

(72) Inventors: Aaron Sippel, Zionsville, IN (US); Matthew R. Gold, Carmel, IN (US)

(21) Appl. No.: 16/144,235

(22) Filed: Sep. 27, 2018

Related U.S. Application Data
(60) Provisional application No. 62/563,922, filed on Sep. 27, 2017.

(51) Int. Cl. F01D 11/12; F01D 25/00

(52) U.S. Cl. CPC F01D 11/122; F01D 25/005; F05D 2220/32; F05D 2240/11; F05D 2300/6033; F05D 2250/184; F05D 2250/283; F05D 2300/20; F05D 2250/183

(57) ABSTRACT

A system may include a component including a substrate and a non-continuous abradable coating on the substrate. The non-continuous abradable coating may include a plurality of respective physical segments. Each respective physical segment may be separated from an adjacent respective physical segment by a respective channel. A respective width of the respective channel between each respective segment and the adjacent respective segment may be greater than a combined maximum thermal expansion of the respective physical segment and the adjacent respective segment toward each other at a maximum design temperature of the component.

This application claims priority to U.S. Provisional Patent Application No. 62/563,922, filed Sep. 27, 2017, the entire contents of which are incorporated herein by reference.

### TECHNICAL FIELD

The present disclosure generally relates to abradable coatings, for example, for high-performance systems including rotating components.

### BACKGROUND

The components of high-performance systems, such as, for example, turbine or compressor components, operate in severe environments. For example, turbine blades, vanes, blade tracks, and blade shrouds exposed to hot gases in commercial aeronautical engines may experience metal surface temperatures of about 1000° C.

High-performance systems may include rotating components, such as blades, rotating adjacent a surrounding structure, for example, a shroud. Reducing the clearance between rotating components and a shroud may improve the power and the efficiency of the high-performance component. The clearance between the rotating component and the shroud may be reduced by coating the blade shroud with an abradable coating. Turbine engines may thus include abradable coatings at a sealing surface or shroud adjacent to rotating parts, for example, blade tips or knife seals. A rotating part, for example, a turbine blade or knife, can abrade a portion of a fixed abradable coating applied on an adjacent stationary part as the turbine blade or knife rotates. Over many rotations, this may wear a groove in the abradable coating corresponding to the path of the turbine blade. The abradable coating may thus form an abradable seal that can reduce the clearance between rotating components and an inner wall of an opposed shroud or knife seal, which can reduce leakage around a tip of the rotating part or guide leakage flow of a working fluid, such as steam or air, across the rotating component, and enhance power and efficiency of the high-performance component.

### SUMMARY

In some examples, the disclosure describes a component that includes a substrate and a non-continuous abradable coating on the substrate. The non-continuous abradable coating may include a plurality of respective physical segments. Each respective physical segment may be separated from an adjacent respective physical segment by a respective channel. The channel extends through an entire thickness of the non-continuous abradable coating, and wherein the channel does not extend through any part of a layer underlying the non-continuous abradable coating.

In some examples, the disclosure describes a system that includes a component that includes a substrate and a non-continuous abradable coating on the substrate. The non-continuous abradable coating may include a plurality of respective physical segments. Each respective physical segment may be separated from an adjacent respective physical segment by a respective channel. The channel extends through an entire thickness of the non-continuous abradable coating, and wherein the channel does not extend through any part of a layer underlying the non-continuous abradable coating. The system also includes a rotating component configured to contact an abradable surface defined by the non-continuous abradable coating with a portion of the rotating component.

In some examples, the disclosure describes a technique that includes positioning a template on a surface of a component and thermal spraying an abradable coating composition on the component. The template causes the abradable coating composition to deposit on the component as a non-continuous abradable coating comprising a plurality of respective physical segments separated by the template. A width of the template between each respective segment and the adjacent respective segment may be greater than a combined maximum thermal expansion of the respective physical segment and the adjacent respective segment toward each other at a maximum design temperature of the component.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic cross-sectional diagram illustrating an example system including a component that includes a substrate and a non-continuous abradable coating on the substrate.

FIG. 2 is a conceptual and schematic partial plan view of an example of a non-continuous abradable coating.

FIG. 3 is a conceptual and schematic partial plan view of an example of a non-continuous abradable coating.

FIG. 4 is a conceptual and schematic partial plan view of an example of a non-continuous abradable coating.

FIG. 5 is a conceptual and schematic partial plan view of an example of a non-continuous abradable coating.

FIG. 6 is a conceptual and schematic partial plan view of an example of a non-continuous abradable coating.

FIG. 7 is a conceptual block diagram illustrating an example system for forming a non-continuous abradable coating.

FIG. 8 is a flow diagram illustrating an example technique for forming a non-continuous abradable coating on a component.

FIGS. 9A-9C are conceptual and schematic partial plan view of an example of a component formed using the technique of FIG. 8 at various stages of the technique.

FIG. 10 is a flow diagram illustrating an example technique for forming an abradable coating including first and second domains on a component

FIG. 11 is a photograph of an example component including an abradable coating that includes a plurality of first domains and a second domain.

FIG. 12 is a photograph of example templates formed from a flexible polymer.

### DETAILED DESCRIPTION

The disclosure describes example systems that include a component including a substrate and a non-continuous abradable coating on the substrate. The non-continuous abradable coating includes a plurality of respective physical segments. The respective physical segments may be separated from each other by a respective channel. The respective channel may accommodate thermal expansion of the respective physical segment and the adjacent physical segment while reduce thermal stress in the non-continuous abradable coating compared to a continuous abradable coating.

For example, the channels in the non-continuous abradable coating may reduce tensile stress in the non-continuous abradable coating that is caused by thermal expansion of the substrate on which the non-continuous abradable coating is disposed. For instance, for an annular blade track, as the substrate is heated and expands, a circumference of the annulus may expand, which may exert a tensile stress in the non-continuous abradable coating in a direction substantially tangential to the surface of the annulus. By separating the non-continuous abradable coating into respective physical segments, the channels may reduce tensile stress in the non-continuous abradable coating due to the expansion of the substrate.

In some examples, the respective channels may extend through a majority of a thickness of the non-continuous abradable coating (e.g., more than 50% of the thickness of the non-continuous abradable coating). For example, the respective channels may extend through at least 75% of the thickness of the non-continuous abradable coating, at least 90% of the thickness of the non-continuous abradable coating, or substantially the entire thickness of the non-continuous abradable coating.

Further, abradable coatings may be applied to the substrate using a thermal spraying technique, such as plasma spraying. Abradable coatings may define a relatively large thickness, such as up to about 2 millimeters (mm) or more. As such, abradable coatings may be applied using multiple passes of the thermal spraying device. For each pass, the thermal spraying device deposits a layer of material on the substrate (or on an underlying layer). This deposited layer then begins to cool, and an additional layer is deposited on the cooling layer. This results in residual stress in the abradable coating. This residual stress reduces bond strength of the abradable coating to an underlying layer and may result in spallation or cracking of the non-continuous abradable coating upon being used in a high temperature environment. This issue with residual stress may be exacerbated in examples in which the non-continuous abradable coating is applied to a continuous blade track or shroud. However, the channels in the non-continuous abradable coating may reduce strain within the non-continuous abradable coating at an interface between the non-continuous abradable coating and an underlying layer, thus increasing bond strength and reducing a likelihood of cracking, spallation, or both.

The shapes and orientations of the respective physical segments and the respective channels may be selected based on predicted airflow and movement of an abrading structure relative to the non-continuous abradable coating, e.g., to control abrasion of the non-continuous abradable coating, airflow between the abrading structure and the non-continuous abradable coating or within the respective channels of the non-continuous abradable coating, or the like.

In some examples, the plurality of respective physical segments and the respective channels may be formed using a template into which coating material for the respective physical segments is introduced. The template may define the respective channels. In this way, the channels may extend through a thickness of the non-continuous abradable coating, which results in substantially complete separation of the respective physical segments, further contributing to the reduction in residual stress and thermal stress experienced by the non-continuous abradable coating.

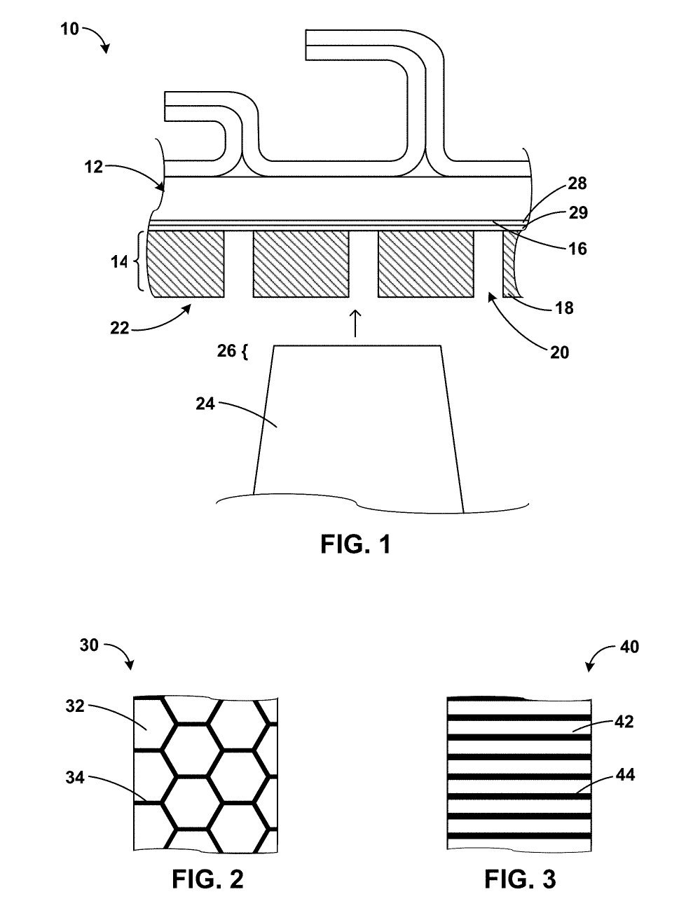

FIG. 1 is a conceptual and schematic cross-sectional diagram illustrating an example system including a component 10 including a substrate 12 and a non-continuous abradable coating 14 on substrate 12. For example, non-continuous abradable coating 14 may be disposed on or adjacent to a major surface 16 defined by substrate 12. Non-continuous abradable coating 14 defines an abradable surface 22.

Component 10 may include a mechanical component operating at relatively high conditions of temperature, pressure, or stress, for example, a component of a turbine, a compressor, or a pump. In some examples, component 10 includes a gas turbine engine component, for example, an aeronautical, marine, or land-based gas turbine engine. Component 10 may include, for example, a blade track or blade shroud or a knife seal runner that circumferentially surrounds a rotating blade or knife.

The example system of FIG. 1 may include a rotating component 24 adjacent to non-continuous abradable coating 14. For example, an end portion 26 or tip of rotating component 24 may be adjacent to non-continuous abradable coating 14, as shown in FIG. 1. Rotating component 24 may include any component rotating adjacent to or along substrate 12. In some examples, rotating component 24 includes a blade, a lobe, or a knife. For example, rotating component 24 may include a compressor or turbine blade. In other examples, rotating component 24 may include a pump or compressor lobe. Thus, in some examples, end portion 26 may include a tip of a blade or an end of a lobe. At least one of abradable surface 22 of non-continuous abradable coating 14 and surface 16 of component 10 may define a flow boundary between rotating component 24 and component 10.

The clearance between end portion 26 of rotating component 24 (for example, a blade tip) and abradable surface 22 may determine the flow boundary thickness, which may affect the efficiency and performance of the system of FIG. 1. In some examples, the flow boundary may be reduced or substantially minimized by allowing or causing contact between portion 26 of rotating component 24 and abradable surface 22 during predetermined operating conditions of high-performance component 10. To allow for continued operation during such contact, end portion 26 may abrade at least a portion of abradable surface 22 of non-continuous abradable coating 14, such that rotating component 24 can continue to rotate while portion 26 contacts abradable track 14. For example, in implementations in which rotating component 24 includes a blade, a blade tip may contact and cut a groove or path into non-continuous abradable coating 14 by abrading successive portions of abradable surface 22 during operation of high-performance component 10. Thus, in some such examples, rotating component 24 may contact abradable surface 22 of non-continuous abradable coating 14 with portion 26 of rotating component 24.

Abradable surface 22 is shown as a substantially level surface in FIG. 1. However, the position, shape, and geometry of abradable surface 22 may also change during operation of high-performance component 10. For example, over a number of cycles of operation, rotating component 24 may cut a groove or another pattern into non-continuous abradable coating 14, redefining abradable surface 22 over successive operating cycles. The groove may or may not be visually perceptible.

In some examples, component 10 may include a substantially cylindrical track or shroud including substrate 12. Non-continuous abradable coating 14 may run along an inner cylindrical surface defined by the cylindrical shroud and substrate 12. For example, abradable surface 22 of non-continuous abradable coating 14 may be substantially cylindrical and conform to a rotating path defined by portion 26 of rotating component 24. Thus, non-continuous abradable coating 14 may define a substantially cylindrical abradable surface 22.

Non-continuous abradable coating 14 is formed on or adjacent to substrate 12. In some examples, substrate 12 may include a metal or alloy substrate, for example, a Ni- or Co-based superalloy substrate, or a ceramic-based substrate, for example, a substrate including ceramic or ceramic matrix composite (CMC). Suitable ceramic materials may include, for example, a silicon-containing ceramic, such as silica (SiO₂), silicon carbide (SiC); silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In some examples in which substrate 12 includes a ceramic, the ceramic may be substantially homogeneous.

In examples in which substrate 12 includes a CMC, substrate 12 may include a matrix material and a reinforcement material. The matrix material may include, for example, silicon metal or a ceramic material, such as silicon carbide (SiC), silicon nitride (Si₃N₄), an aluminosilicate, silica (SiO₂), a transition metal carbide or silicide (e.g., WC, Mo₂C, TiC, MoSi₂, NbSi₂, TiSi₂), or other ceramics described herein. The CMC may further include a continuous or discontinuous reinforcement material. For example, the reinforcement material may include discontinuous whiskers, platelets, fibers, or particulates. Additionally, or alternatively, the reinforcement material may include a continuous monofilament or multifilament two-dimensional or three-dimensional weave. In some examples, the reinforcement material may include carbon (C), silicon carbide (SiC), silicon nitride (Si₃N₄), an aluminosilicate, silica (SiO₂), a transition metal carbide or silicide (e.g. WC, Mo₂C, TiC, MoSi₂, NbSi₂, TiSi₂), another ceramic material described herein, or the like.

In some examples, the composition of the reinforcement material is the same as the composition of the matrix material. For example, a matrix material comprising silicon carbide may surround a reinforcement material including silicon carbide whiskers. In other examples, the reinforcement material includes a different composition than the composition of the matrix material, such as aluminosilicate fibers in an alumina matrix, or the like. One composition of substrate 12 that includes a CMC is a reinforcement material of silicon carbide continuous fibers embedded in a matrix material of silicon carbide. In some examples, substrate 12 includes a SiC—SiC CMC. In some examples in which substrate 12 includes CMC, the CMC may include a plurality of plies, for example, plies of reinforcing fibers.

In some examples, substrate 12 may be provided with one or more coatings in addition to non-continuous abradable coating 14. In examples in which substrate 12 is coated with one or more coatings, major surface 16 may be defined by the one or more coatings. For example, substrate 12 may be coated with an optional bond coat 28. Bond coat 28 may be deposited on or deposited directly on substrate 12 to promote adhesion between substrate 12 and one or more additional layers deposited on bond coat 28, including, for example, non-continuous abradable coating 14, or barrier coatings such as environmental or thermal barrier coatings. Bond coat 28 may promote the adhesion or retention of abradable track 14 on substrate 12, or of additional coatings on substrate 12 or high-performance component 10.

The composition of bond coat 28 may be selected based on a number of considerations, including the chemical composition and phase constitution of substrate 12 and the layer overlying bond coat 28 (in FIG. 1, non-continuous abradable coating 14). For example, when substrate 12 includes a superalloy with a γ-Ni γ′-Ni Al phase constitution, bond coat 28 may include a y-Ni+y′-NiAl phase constitution to better match the coefficient of thermal expansion of substrate 12. This may increase the mechanical stability (adhesion) of bond coat 28 to substrate 12. In examples in which substrate 12 includes a superalloy, bond coat 28 may include an alloy, such as an MCrAlY alloy (where M is Ni, Co, or NiCo), a β-NiAl nickel aluminide alloy (either unmodified or modified by Pt, Cr, Hf, Zr, Y, Si, and combinations thereof), a γ-Ni γ′-Ni Al nickel aluminide alloy (either unmodified or modified by Pt, Cr, Hf, Zr, Y, Si, and combination thereof), or the like. In some examples, bond coat 28 includes Pt.

In examples where substrate 12 includes a ceramic or CMC, bond coat 28 may include a ceramic or another material that is compatible with the substrate 12. For example, bond coat 28 may include mullite (aluminum silicate, Al₆Si₂O₁₃), silicon metal, silicon alloys, silica, a silicide, or the like. In some examples, bond coat 28 may include transition metal nitrides, carbides, or borides. Bond coat 28 may further include ceramics, other elements, or compounds, such as silicates of rare earth elements (i.e., a rare earth silicate) including Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium), La (lanthanum), Y (yttrium), or Sc (scandium). Some preferred compositions of bond coat 28 formed on a substrate 12 formed of a ceramic or CMC include silicon metal, mullite, an yttrium silicate or an ytterbium silicate.

Bond coat 28 may be applied by thermal spraying, including, plasma spraying, high velocity oxygen fuel (HVOF) spraying, low vapor plasma spraying; plasma vapor deposition (PVD), including electron-beam PVD (EB-PVD), direct vapor deposition (DVD), and cathodic arc deposition; chemical vapor deposition (CVD); slurry process deposition; sol-gel process deposition; electrophoretic deposition; or the like.

In some examples, substrate 12 additionally, or alternatively, may be coated with a barrier coating 29. Barrier coating 29 may include at least one of a thermal barrier coating (TBC) or an environmental barrier coating (EBC) to reduce surface temperatures and prevent migration or diffusion of molecular, atomic, or ionic species from or to substrate 12. The TBC or EBC may allow use of component 10 at relatively higher temperatures compared to component 10 without the TBC or EBC, which may improve efficiency of component 10.

Example EBCs include, but are not limited to, mullite; glass ceramics such as barium strontium alumina silicate (BaOx-SrO1-x-Al₂O₃-2SiO₂; BSAS), barium alumina silicate (BaO—Al₂O₃-2SiO₂; BAS), calcium alumina silicate (CaO—Al₂O₃-2SiO₂), strontium alumina silicate (SrO—Al₂O₃-2SiO₂; SAS), lithium alumina silicate (Li₂O—Al₂O₃-2SiO₂; LAS) and magnesium alumina silicate (2MgO-2Al₂O₃-5SiO₂; MAS); rare earth silicates, and the like. An example rare earth silicate for use in an environmental barrier coating is ytterbium silicate, such as ytterbium monosilicate or ytterbium disilicate. In some examples, an environmental barrier coating may be substantially dense, e.g., may include a porosity of less than about 5 vol. % to reduce migration of environmental species, such as oxygen or water vapor, to substrate 12.

Examples of TBCs, which may provide thermal insulation to the CMC substrate to lower the temperature experienced by the substrate, include, but are not limited to, insulative materials such as ceramic layers with zirconia or hafnia. In some examples, the TBC may include multiple layers. The TBC or a layer of the TBC may include a base oxide of either zirconia or hafnia and a first rare earth oxide of yttria. For example, the TBC or a layer of the TBC may consist essentially of zirconia and yttria. As used herein, to “consist essentially of” means to consist of the listed element(s) or compound(s), while allowing the inclusion of impurities present in small amounts such that the impurities do no substantially affect the properties of the listed element or compound.

In some examples, the TBC or a layer of the TBC may include a base oxide of zirconia or hafnia and at least one rare earth oxide, such as, for example, oxides of Lu, Yb, Tm, Er, Ho, Dy, Gd, Tb, Eu, Sm, Pm, Nd, Pr, Ce, La, Y, Sc. For example, a TBC or a TBC layer may include predominately (e.g., the main component or a majority) the base oxide zirconia or hafnia mixed with a minority amounts of the at least one rare earth oxide. In some examples, a TBC or a TBC layer may include the base oxide and a first rare earth oxide including ytterbia, a second rare earth oxide including samaria, and a third rare earth oxide including at least one of lutetia, scandia, ceria, neodymia, europia, and gadolinia. In some examples, the third rare earth oxide may include gadolinia such that the TBC or the TBC layer may include zirconia, ytterbia, samaria, and gadolinia. The TBC or the TBC layer may optionally include other elements or compounds to modify a desired characteristic of the coating, such as, for example, phase stability, thermal conductivity, or the like. Example additive elements or compounds include, for example, rare earth oxides. The inclusion of one or more rare earth oxides, such as ytterbia, gadolinia, and samaria, within a layer of predominately zirconia may help decrease the thermal conductivity of a TBC layer, e.g., compared to a TBC layer including zirconia and yttria. While not wishing to be bound by any specific theory, the inclusion of ytterbia, gadolinia, and samaria in a TBC layer may reduce thermal conductivity through one or more mechanisms, including phonon scattering due to point defects and grain boundaries in the zirconia crystal lattice due to the rare earth oxides, reduction of sintering, and porosity.

In some examples in which barrier coating 29 includes both the TBC and the EBC, either one of the TBC or the EBC may be disposed adjacent bond coat 28 or substrate 12, and the other one of the TBC or the EBC may be disposed opposed to and away from adjacent bond coat 28 or substrate 12. In some examples in which component 10 includes bond coat 28, and in which barrier coating 29 includes both the TBC and the EBC, the TBC may be between bond coat 28 and the EBC, or the EBC may be between bond coat 28 and the TBC. Barrier coating 29 (including one or more of the EBC, the TBC, or other layers) may be applied by thermal spraying, including, plasma spraying, high velocity oxygen fuel (HVOF) spraying, low vapor plasma spraying; plasma vapor deposition (PVD), including electron-beam PVD (EB-PVD), direct vapor deposition (DVD), and cathodic arc deposition; chemical vapor deposition (CVD); slurry process deposition; sol-gel process deposition; electrophoretic deposition; or the like. One or both of bond coat 28 and barrier coating 29 may be at least partially disposed or formed over major surface 16.

Substrate 12 may define a substantially smooth surface 16. Substantially smooth surfaces according to the disclosure may include surfaces that exhibit a contour deviation within a predetermined constraint. In some examples, major surface 16 may define three-dimensional surface features, such as pits, grooves, depressions, stripes, columns, protrusions, ridges, or the like, or combinations thereof. In some such examples, the surface features may increase mechanical adhesion between non-continuous abradable coating 14 and substrate 12.

While one rotating component 24 is shown in the example illustrated in FIG. 1, a plurality of rotating components may include rotating component 24, and one or more of rotating components of the plurality of rotating components may contact and abrade non-continuous abradable coating 14, for example, in series or in succession. While component 10 may include rotating component 24, in some examples, component 10 may include, instead of, or in addition to rotating component 24, at least one moving or vibrating component defining an end portion adjacent to non-continuous abradable coating 14. Thus, in some such examples, an end portion of at least one moving or vibrating component may contact and abrade non-continuous abradable coating 14.

Thus, in some examples, a gas turbine system may include component 10 according to the disclosure, and further include rotating component 24 configured to contact, cut, scrape, or abrade surface 22 of non-continuous abradable coating 14 with end portion 26 of rotating component 24 during predetermined operating conditions of component 10. In examples in which component 10 includes an aeronautical gas turbine engine, the predetermined operating conditions may include a cruising condition. For example, shortly after starting up the engine, the engine may be relatively colder than the typical operating temperatures of the engine. During the start-up period, a relatively higher clearance may be maintained between end portions of rotating components of the engine, for example, end portion 26 of rotating component 24 and non-continuous abradable coating 14, to reduce the torque requirements. As the temperature of the engine rises to operating temperatures, the increased temperatures may cause thermal expansion in the blade, causing end portion 26 to contact non-continuous abradable coating 14. Thus, the clearance may be reduced during typical operating conditions of the engine.

As shown in FIG. 1, non-continuous abradable coating 14 includes a plurality of respective physical segments 18 separated by respective channels 20. Each respective physical segment of the plurality of respective physical segments 18 is separated from an adjacent physical segment by a respective channel of the plurality of respective channels 20.

Physical segments 18 of non-continuous abradable coating 14 may include any suitable abradable composition capable of being abraded by rotating component 24. For example, the abradable composition may exhibit a hardness that is relatively lower than a hardness of portion 26 of rotating component 24 such that portion 26 can abrade the porous abradable composition by contact. Thus, the hardness of physical segments 18 relative to the hardness of portion 26 may be indicative of the abradability of non-continuous abradable coating 14.

While the abradability of non-continuous abradable coating 14 may depend on the respective composition of physical segments 18, for example, the physical and mechanical properties of the composition, the abradability of the layer may also depend on a porosity of physical segments 18. For example, a relatively porous composition may exhibit a higher abradability compared to a relatively nonporous composition, and a composition with a relatively higher porosity may exhibit a higher abradability compared to a composition with a relatively lower porosity, everything else remaining the same. Further, the abradability of non-continuous abradable coating 14 may depend on the relative size and distribution of channels 20 and physical segments 18. For example, a non-continuous abradable coating 14 with a higher areal density of channels 20 may be more easily abradable compared to a non-continuous abradable coating 14 with a lower areal density of channels 20.

Thus, in some examples, physical segments 18 may include an abradable composition. For example, the abradable composition may include a matrix composition. The matrix composition of the abradable composition may include at least one of aluminum nitride, aluminum diboride, boron carbide, aluminum oxide, mullite, zirconium oxide, carbon, silicon carbide, silicon nitride, silicon metal, silicon alloy, a transition metal nitride, a transition metal boride, a rare earth oxide, a rare earth silicate, zirconium oxide, a stabilized zirconium oxide (for example, yttria-stabilized zirconia), a stabilized hafnium oxide (for example, yttria-stabilized hafnia), barium-strontium-aluminum silicate, or mixtures and combinations thereof. In some examples, the abradable composition includes at least one silicate, which may refer to a synthetic or naturally-occurring compound including silicon and oxygen. Suitable silicates include, but are not limited to, rare earth disilicates, rare earth monosilicates, barium strontium aluminum silicate, and mixtures and combinations thereof.

In some examples, the abradable composition may include a base oxide of zirconia or hafnia and at least one rare earth oxide, such as, for example, oxides of Lu, Yb, Tm, Er, Ho, Dy, Gd, Tb, Eu, Sm, Pm, Nd, Pr, Ce, La, Y, Sc. For example, the abradable composition may include predominately (e.g., the main component or a majority) the base oxide zirconia or hafnia mixed with a minority amounts of the at least one rare earth oxide. In some examples, the abradable composition may include the base oxide and a first rare earth oxide including ytterbia, a second rare earth oxide including samaria, and a third rare earth oxide including at least one of lutetia, scandia, ceria, neodymia, europia, and gadolinia. In some examples, the third rare earth oxide may include gadolinia such that the abradable composition may include zirconia, ytterbia, samaria, and gadolinia. The abradable composition may optionally include other elements or compounds to modify a desired characteristic of the coating, such as, for example, phase stability, thermal conductivity, or the like. Example additive elements or compounds include, for example, rare earth oxides. The inclusion of one or more rare earth oxides, such as ytterbia, gadolinia, and samaria, within a layer of predominately zirconia may help decrease the thermal conductivity of the abradable composition, e.g., compared to a composition including zirconia and yttria. While not wishing to be bound by any specific theory, the inclusion of ytterbia, gadolinia, and samaria in the abradable composition may reduce thermal conductivity through one or more mechanisms, including phonon scattering due to point defects and grain boundaries in the zirconia crystal lattice due to the rare earth oxides, reduction of sintering, and porosity.

In examples in which the abradable composition includes a plurality of pores, the plurality of pores may include at least one of interconnected voids, unconnected voids, partly connected voids, spheroidal voids, ellipsoidal voids, irregular voids, or voids having any predetermined geometry, and networks thereof. In some examples, adjacent faces or surfaces of agglomerated, sintered, or packed particles or grains in the porous abradable composition may define the plurality of pores. The porous abradable composition may exhibit any suitable predetermined porosity to provide a predetermined abradability to non-continuous abradable coating 14 including the porous abradable composition. In some examples, the porous abradable composition may exhibit a porosity between about 10 vol. % and about 50 vol. %, or between about 10 vol. % and about 40 vol. %, or between about 15 vol. % and 35 vol. %, or about 25 vol. %. Without being bound by theory, a porosity higher than 40 vol. % may substantially increase the fragility and erodibility of physical segments 18, reduce the integrity of non-continuous abradable coating 14, and can lead to spallation of portions of non-continuous abradable coating 14 instead of controlled abrasion of non-continuous abradable coating 14.

The abradable composition, whether including pores or not, may be formed by any suitable technique, for example, example techniques including thermal spraying according to the disclosure. Thus, in some examples, the abradable composition may include a thermal sprayed composition. The thermal sprayed composition may define pores formed as a result of thermal spraying, for example, resulting from agglomeration, sintering, or packing of grains or particles during the thermal spraying.

In some examples, the thermally sprayed composition may include a fugitive material configured to define pores in response to thermal treatment dispersed in the matrix composition. The fugitive material may be disintegrated, dissipated, charred, or burned off by heat exposure during the thermal spraying, or during a post-formation heat treatment, or during operation of component 10, leaving voids in the matrix composition defining the plurality of pores. The post-deposition heat-treatment may be performed at up to about 1150° C. for a component having a substrate 12 that includes a superalloy, or at up to about 1500° C. for a component having a substrate 12 that includes a CMC or other ceramic. For example, the fugitive material may include at least one of graphite, hexagonal boron nitride, or a polymer. In some examples, the polymer may include a polyester. The shapes of the grains or particles of the fugitive material may determine the shape of the pores. For example, the fugitive material may include particles having spheroidal, ellipsoidal, cuboidal, or other predetermined geometry, or flakes, rods, grains, or any other predetermined shapes or combinations thereof, and may be thermally sacrificed by heating to leave voids having respective complementary shapes.

The concentration of the fugitive material may be controlled to cause the porous abradable composition to exhibit a predetermined porosity, for example, a porosity between about 10% and about 40%. For example, a higher concentration of the fugitive material may result in a higher porosity, while a lower concentration of the fugitive material may result in a lower porosity. Thus, for a predetermined matrix composition, the porosity of the abradable composition may be changed to impart a predetermined abradability to a layer of abradable track 14 including the porous composition. The porosity may also be controlled by using fugitive materials or processing techniques to provide a predetermined porosity.

Each channel of channels 20 may extend at least partially through a thickness of non-continuous abradable coating 14, as measured in a direction substantially normal to major surface 16, from abradable surface 22. For example, a respective channel of channels 20 may extend through a majority of a thickness of non-continuous abradable coating 14 (e.g., more than 50% of the thickness of non-continuous abradable coating 14). In some examples, a respective channel of channels 20 may extend through at least 75% of the thickness of the non-continuous abradable coating 14, at least 90% of the thickness of non-continuous abradable coating 14, or substantially the entire thickness of non-continuous abradable coating 14.

However, in some examples in which channels 20 extend through substantially the entire thickness of non-continuous abradable coating 14, channels 20 may not extend into an underlying layer, such as barrier layer 29, bond coat 28, or substrate 12. By channels 20 not extending into an underling layer, the physical integrity of the underlying layer may be maintained, which may allow the underlying layer to better perform its function than if channels 20 were to extend into the underlying layer.

Channels 20 may define any geometry, including depth, width, shape, cross-sectional shape, spacing between adjacent channels, and the like. The shapes and orientations of the respective physical segments 18 and the respective channels 20 may be selected based on predicted airflow and movement of blade tip 26 relative to non-continuous abradable coating 14, e.g., to control abrasion of non-continuous abradable coating 14, airflow between blade tip 26 and non-continuous abradable coating 14 or within the respective channels 20 of-continuous abradable coating 14, or the like.

For example, as described above, a depth of channels 20 may be a majority of a thickness of non-continuous abradable coating 14, may be greater than about 75% of a thickness of non-continuous abradable coating 14, may be greater than about 90% of a thickness of non-continuous abradable coating 14, or may be substantially equal to the thickness of non-continuous abradable coating 14.

In some examples, the width of channels 20 may be selected, for example, based on a coefficient of thermal expansion of the abradable composition from which physical segments 18 are formed and a temperature or temperature range associated with component 10. For example, the width of channels 20 may be selected to be greater than a combined maximum thermal expansion of the respective physical segment and the adjacent respective segment toward each other at a maximum design temperature of the component. The combined maximum thermal expansion may be determined based on, for example, a linear coefficient of thermal expansion of the abradable composition, a width of the physical segments 18 parallel to major surface 16, and a maximum temperature to which non-continuous abradable coating 14 is exposed during use or component 10. This may allow calculation of a maximum size expansion of the physical segments 18 from ambient temperature to the maximum temperature, and the width of channels 20 may be selected to be greater than this calculated maximum size.

In some examples, the width of channels 20 may vary as a function of depth of the channels 20. For example, abradable surface 22 may experience higher temperatures than a portion of non-continuous abradable coating 14 adjacent to barrier coating 29. As such, in some examples, a width of channels 20 may be greater adjacent to abradable surface 22 and lesser adjacent to barrier coating 29 (or another underlying layer). In examples in which the width of channels 20 varies as a function of depth, the width may vary linearly, exponentially, or the like. In some examples in which the width of channels 20 varies as a function of depth, the width of channels 20 at each respective depth may be selected to be greater than a combined maximum thermal expansion of the respective physical segment (at the respective depth) and the adjacent respective segment (at the respective depth) toward each other at a maximum design temperature of the component.

In general, channels 20 may define any selected cross-sectional shape, including, for example, rectangular, curvilinear, curved, or the like.

The spacing between adjacent channels of channels 20 may be selected to achieve a desired combination of abradability, reduction of thermal and residual stress, airflow blocking, or the like. For example, a smaller spacing between adjacent channels of channels 20 may improve abradability and reduce thermal and residual stress in non-continuous abradable coating 14 but may increase fluid flow around end portion 26 or tip of rotating component 24. On the other hand, a larger spacing between adjacent channels of channels 20 may reduce abradability and increase thermal and residual stress in non-continuous abradable coating 14 but may reduce fluid flow around end portion 26 or tip of rotating component 24. As such, spacing between adjacent channels of channels 20 may be selected to balance, for example, abradability, reduction of thermal and residual stress, airflow blocking, or the like.

In addition to the spacing, width, and depth of channels 20, the pattern of channels 20 also may affect properties of non-continuous abradable coating 14. As such, a pattern of channels 20 may be selected to impact performance of non-continuous abradable coating 14. FIGS. 2-6 are conceptual and schematic partial plan views of examples of a non-continuous abradable coating.

For example, FIG. 2 illustrates an example non-continuous coating 30 including a honeycomb pattern. As shown in FIG. 2, cells 32 of the honeycomb pattern may include physical segments including abradable coating material, and channel 34 defines the border between respective cells 32 of the honeycomb pattern. In other examples, the structure labeled with reference numeral 34 may include physical segments including abradable coating material, and the structure labeled with reference numeral 32 may be channels. Regardless, the size, shape, spacing, and the like of cells 32 and channel 34 may be selected based on the considerations described above.

FIG. 3 illustrates an example non-continuous abradable coating 40 that includes a linear pattern. Physical segments 42 include abradable coating material and channels 44 are gaps between adjacent physical segments 42. The size, shape, spacing, and the like of physical segments 42 and channels 44 may be selected based on the considerations described above. In some examples in which non-continuous abradable coating 40 is on an inner surface of a blade track or blade shroud that defines a cylinder, channels 44 may be substantially parallel to an axis of the substantially cylindrical blade track or blade shroud. In other examples in which non-continuous abradable coating 40 is on an inner surface of a blade track or blade shroud that defines a cylinder, channels 44 may be substantially perpendicular to an axis of the substantially cylindrical blade track or blade shroud.

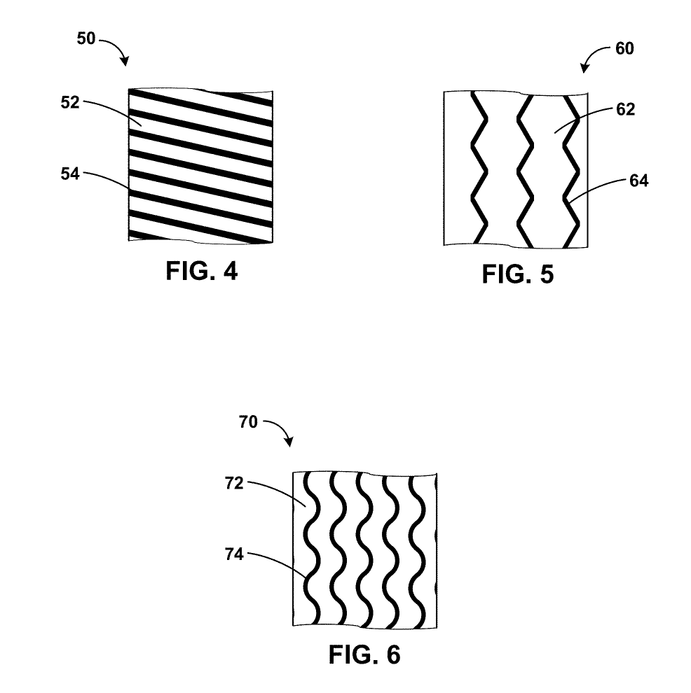

FIG. 4 illustrates an example non-continuous abradable coating 50 that includes a linear pattern. Physical segments 52 include abradable coating material and channels 54 are gaps between adjacent physical segments 52. The size, shape, spacing, and the like of physical segments 52 and channels 54 may be selected based on the considerations described above. In some examples in which non-continuous abradable coating 50 is on an inner surface of a blade track or blade shroud that defines a cylinder, the channels 54 may be canted (e.g., angled) with respect to an axis of the substantially cylindrical blade track or blade shroud. In some examples, a direction of the cant (e.g., angle) of the plurality of channels 54 is opposite to a swirl of fluid traveling along a surface of non-continuous abradable coating 50. The direction and angle of the cant may reduce airflow flowing between a tip of an abrading component and channels 54.

FIG. 5 illustrates an example non-continuous abradable coating 60 that includes a zig-zag pattern. Physical segments 62 include abradable coating material and channels 64 are gaps between adjacent physical segments 62. The size, shape, spacing, and the like of physical segments 62 and channels 64 may be selected based on the considerations described above. In some examples in which non-continuous abradable coating 60 is on an inner surface of a blade track or blade shroud that defines a cylinder, channels 64 may be substantially parallel to an axis of the substantially cylindrical blade track or blade shroud. In other examples in which non-continuous abradable coating 60 is on an inner surface of a blade track or blade shroud that defines a cylinder, channels 64 may be substantially perpendicular to an axis of the substantially cylindrical blade track or blade shroud.

FIG. 6 illustrates an example non-continuous abradable coating 70 that includes a sinusoidal pattern. Physical segments 72 include abradable coating material and channels 74 are gaps between adjacent physical segments 72. The size, shape, spacing, and the like of physical segments 72 and channels 74 may be selected based on the considerations described above. In some examples in which non-continuous abradable coating 70 is on an inner surface of a blade track or blade shroud that defines a cylinder, channels 74 may be substantially parallel to an axis of the substantially cylindrical blade track or blade shroud. In other examples in which non-continuous abradable coating 70 is on an inner surface of a blade track or blade shroud that defines a cylinder, channels 74 may be substantially perpendicular to an axis of the substantially cylindrical blade track or blade shroud.

Other geometries for the channels are also contemplated. For example, the channels may define non-continuous shapes, such as non-continuous honeycomb patterns (e.g., discrete hexagons), non-continuous lines, sinusoids, zig-zags, staggered grooves, or the like.

Non-continuous abradable coatings 14, 30, 40, 50, 60, 70 may be applied to the substrate using a thermal spraying technique, such as plasma spraying. Non-continuous abradable coatings 14, 30, 40, 50, 60, 70 may define a relatively large thickness, such as up to about 2 millimeters (mm) or more. As such, abradable coatings may be applied using multiple passes of the thermal spraying device. For each pass, the thermal spraying device deposits a layer of material on the substrate (or an underlying layer). This deposited layer then begins to cool, and an additional layer is deposited on the cooling layer. This results in residual stress in the abradable coating. This residual stress reduces bond strength of the abradable coating to an underlying layer and may result in spallation or cracking of the non-continuous abradable coating upon being used in a high temperature environment. This issue with residual stress may be exacerbated in examples in which non-continuous abradable coating 14, 30, 40, 50, 60, 70 is applied to a continuous blade track or shroud. However, channels 20, 34, 44, 54, 64, 74 in the non-continuous abradable coating 14, 30, 40, 50, 60, 70 may reduce strain within the non-continuous abradable coating 14, 30, 40, 50, 60, 70 at an interface between the non-continuous abradable coating 14, 30, 40, 50, 60, 70 and an underlying layer (e.g., barrier layer 29, bond coating 28, or substrate 120, thus increasing bond strength and reducing a likelihood of cracking, spallation, or both.

In some examples, channels 20, 34, 44, 54, 64, 74 may be formed in non-continuous abradable coating 14, 30, 40, 50, 60, 70 by mechanical removal of portions of abradable coating material after deposition of the abradable coating material on component 10. However, in some examples, this may not efficiently reduce residual stress in non-continuous abradable coating 14, 30, 40, 50, 60, 70. Hence, in some examples, channels 20, 34, 44, 54, 64, 74 may be defined in non-continuous abradable coating 14, 30, 40, 50, 60, 70 as part of forming non-continuous abradable coating 14, 30, 40, 50, 60, 70.

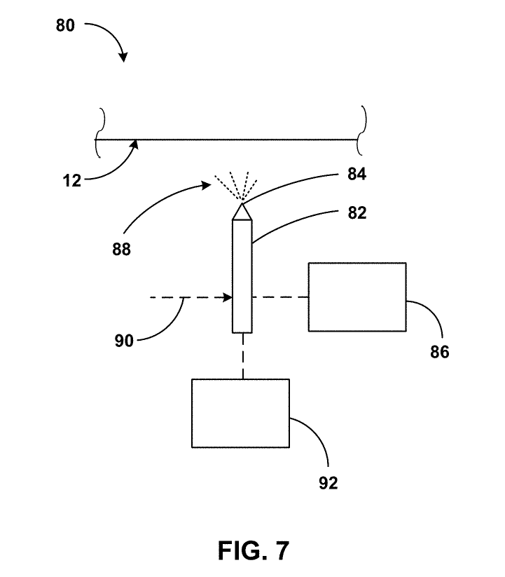

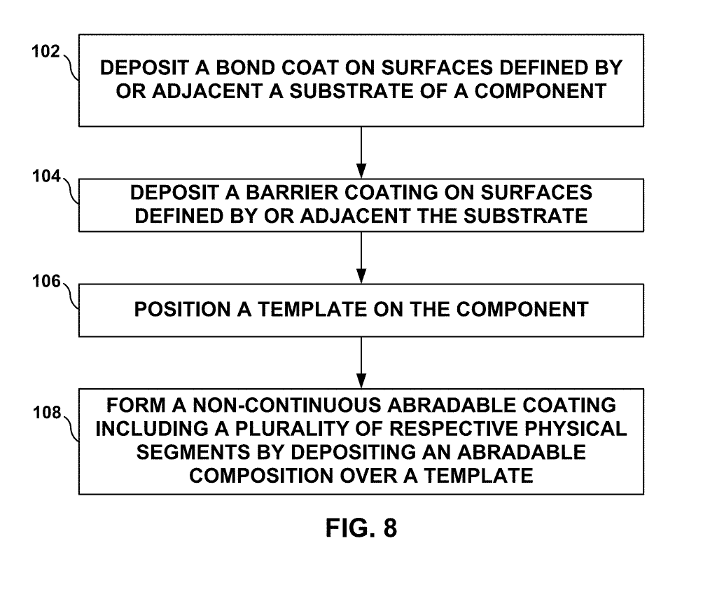

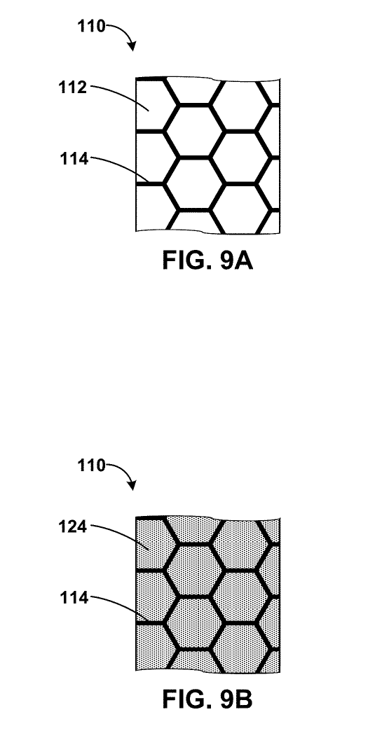

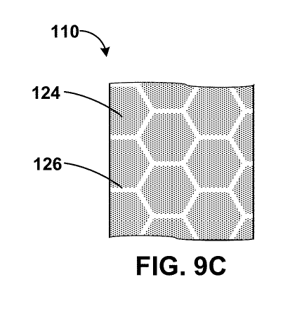

FIG. 7 is a conceptual and schematic block diagram illustrating an example system 80 for forming a multilayer abradable track on a high-performance component. Operation of system 80 will be described with concurrent reference to the technique of FIG. 8 and the conceptual diagrams of FIGS. 9A-9C. FIG. 8 is a flow diagram illustrating an example technique for forming a non-continuous abradable coating on a component. FIGS. 9A-9C are conceptual and schematic partial plan view of an example of a component formed using the technique of FIG. 8 at various stages of the technique.

System 80 includes a spray gun 82 having a nozzle 84 coupled to a reservoir 86. Reservoir 86 holds a precursor composition sprayed as a spray 88 through nozzle 84. System 80 may further include a stream 90 including a working fluid or a gas, for example, a fluid or gas ignitable or energizable to form a plasma, or a fluid including a fuel ignitable to form a high velocity oxygen fuel stream. System 80 may include an igniter (not shown) to ignite the plasma or fuel stream. System 80 may include a platform, an articulating or telescoping mount, a robotic arm, or the like to hold, orient, and move spray gun 82 and/or substrate 12. Spray gun 82 may be held, oriented, moved, or operated manually by an operator, or semi-automatically or automatically with the assistance of a controller. While system 80 may include one spray gun 82 as shown in FIG. 7, in other examples, system 80 may include more than one spray gun, for example, dedicated spray guns for respective precursor compositions in reservoir 86.

System 80 may include a controller 92 to control the operation of spray gun 82. Controller 92 may include control circuitry to control one or more of the flow rate of the spray composition or of stream 90, the pressure, temperature, nozzle aperture, spray diameter, or the relative orientation, position, or distance of nozzle 84 with respect to substrate 12. The control circuitry may receive control signals from a processor or from an operator console. In some examples, controller 92 may be implemented as a desktop computer, a laptop computer, a tablet computer, a workstation, a server, a mainframe, a cloud computing system, a robot controller, or the like. The control circuitry may include, for example, any one or more of a microprocessor, a controller, a digital signal processor (DSP), an application specific integrated circuit (ASIC), a field-programmable gate array (FPGA), or equivalent discrete or integrated logic circuitry.

In some examples, system 80 may include a booth or a chamber (not shown) at least partly surrounding spray gun 84 and substrate 12 to shield the environment from spray 88 and from the operating conditions of the spraying. In some such examples, one or both of reservoir 86 or controller 90 may be outside the booth or chamber. System 80 may be used to form non-continuous abradable coating 14 on substrate 12 according to an example technique described with reference to FIG. 8.

In some examples, the technique of FIG. 8 may be performed on a pre-machined substrate, for example substrate 12 pre-machined or otherwise fabricated. The example technique of FIG. 8 may optionally include at least one of: depositing bond coat 28 on surfaces defined by or adjacent to substrate 12 (102); or depositing barrier coating 29 on surfaces defined by or adjacent to substrate 12 (104). One or both of depositing of bond coat 28 (102) or depositing of barrier coating 29 (104) may include at least one of thermal spraying, plasma spraying, physical vapor deposition, chemical vapor deposition, or any other suitable technique.

The example technique of FIG. 8 includes positioning a template on component 110 (106). For example, as shown in FIG. 9A, template 114 may include at least one wall that defines a position at which coating material will not be deposited onto the underlying component 110, and leaves portions of substrate 112 exposed. In this way, the position of the at least one wall defines the position of the at least one channel in the non-continuous abradable coating. In the example shown in FIG. 9A, template 114 includes at least one wall that defines honeycomb shapes, with the at least one wall defining the border between adjacent cells of the honeycomb. In other examples in which the channels have other geometries, the at least one wall of template 114 may define other shapes, such as, for example, lines, curves, sinusoids, zig-zags, or the like.

Template 114 may be formed from any suitable material, e.g., any material that substantially maintains its shape at temperatures experienced by template 114 during thermal spraying of the non-continuous abradable coating. For example, the material from which template 114 is formed may be capable of withstanding a temperature of about 250° C. Example materials for template 114 may include a silicone rubber, a polyimide, a polyamide, a fluoropolymer, a metal, or the like. In some examples, template 114 may be formed using a molding process, in which template 114 is initially formed using a negative mold. The negative mold may define voids corresponding to the shape of template 114. In some examples, the mold additionally may define one or more features for positioning template 114 relative to substrate 112, restraining template 114 relative to substrate 112, or both. For example, the mold may define one or more straps, bands, hooks, or the like to facilitate positioning template 114 relative to substrate 112, restraining template 114 relative to substrate 112, or both. In some examples, the mold may be formed by 3D printing (or additive manufacturing) a suitable mold material.

In some examples, rather than forming template 114 using molding, template 114 may be 3D printed (or additively manufactured) using a suitable high-temperature material, such as a silicone rubber, a polyimide, a polyamide, a fluoropolymer, a metal, or the like.

In some implementations, template 114 may be adhered to the surface of substrate 112 (or bond coating 28 or barrier coating 29) using a high temperature adhesive. In other implementations, adhesion between template 114 and the surface of substrate 112 (or bond coating 28 or barrier coating 29) may be sufficiently high that the adhesive may be omitted.

Once template 114 has been positioned on component 110 (106), the technique of FIG. 8 includes forming a non-continuous abradable coating that includes a plurality of respective physical segments by depositing an abradable coating composition at substrate 112 of component 110 over template 114 (108). In some examples, the depositing (108) may include a thermal spraying technique suitable for spraying the abradable coating composition to form coatings including metals, alloys, or ceramics, for example, plasma spraying, high velocity oxygen fuel (HVOF) spraying, or wire arc spraying. The thermal spraying may include introducing the at least one abradable coating composition into an energized flow stream (for example, an ignited plasma stream) to result in at least partial fusion or melting of the abradable coating composition and directing or propelling the abradable coating composition toward substrate 112. The propelled abradable coating composition impacts exposed portions of substrate 112 to form a portion of non-continuous abradable coating 124, as shown in FIG. 9B.

The abradable coating composition may include a matrix composition described elsewhere in the disclosure. One or more of the spray duration, spray flow rate, or number of passes at a given location may determine the thickness of non-continuous abradable coating 124 deposited by thermal spraying. For example, an increase in the duration, in the flow rate, or the number of passes may increase the thickness non-continuous abradable coating 124, while a reduction in the duration, flow rate, or number of passes may maintain the thickness of non-continuous abradable coating 124 below or at a predetermined thickness.

In some examples, the abradable coating composition may be suspended or dispersed in a carrier medium, for example, a liquid or a gas. The abradable coating composition may also include a fugitive material (described elsewhere in the disclosure) configured to define pores in response to thermal treatment. In some examples, the fugitive material may be sacrificially removed in response to heat subjected by the thermal spraying, or by a separate heat treatment. For example, the technique of FIG. 8 may optionally include heat treating non-continuous abradable coating 124 after depositing non-continuous abradable coating 124.

The heat treating may result in removal or disintegration of the fugitive material to leave pores forming non-continuous abradable coating 124 having a predetermined porosity. In some examples, heat treating may, instead of, or in addition to, removing the fugitive material, also change the physical, chemical, mechanical, material, or metallurgical properties of at least one layer of non-continuous abradable coating 124. For example, the heat treating may anneal or sinter at least one layer of abradable track formed by the thermal spraying, resulting in an increase in strength or integrity of non-continuous abradable coating 124 compared to un-annealed or un-sintered non-continuous abradable coating 124.

In some examples, the heat treating additionally may cause removal of template 114, e.g., via burning off, melting, or the like.

The heat treatment may be at a temperature of between about 600° C. and about 700° C. In other examples, the technique of FIG. 8 may omit the heat treating, and the fugitive material, if present, and template 114 may burn off or otherwise be removed upon use of component 110 at high temperature, or template 114 may be removed mechanically. Upon removal of template 114, component 110 includes a non-continuous abradable coating 124 including a plurality of physical segments separated by channels 126. In some examples, template 114 causes the abradable coating composition to not be deposited on portions of the surface of the component (e.g., substrate 112, bond coating 28, or barrier coating 29) under the template 114.

In other examples, rather than thermal spraying, forming the non-continuous abradable coating that includes the plurality of respective physical segments by depositing a coating composition at substrate 112 of component 110 over template 114 (108) may use a slurry deposition process. For example, the abradable coating composition may include a slurry including a liquid carrier, a matrix composition described above, and one or more optional additive (e.g., a fugitive material, a dispersant, or the like). The slurry may be deposited over the template using any suitable technique, such as spreading, brushing, spraying, dip coating, or the like. The slurry may then be dried to remove the liquid carrier and heated (like in the thermal spraying described above) to remove the optional fugitive material, the template, or both.

In some examples, rather than a non-continuous abradable coating including a channel that is free from material, an abradable coating may include discrete domains of a first material and discrete domains of a second material. The first domains, the second domains, or both may be discontinuous in two dimensions (e.g., a first dimension parallel to a surface of a substrate and a second dimension parallel to the surface of the substrate and perpendicular to the first dimension).

The first domains may include material having a first effective abradability and the second domains may include material having a second effective abradability. The first effective abradability may be less than the second effective abradability (i.e., the first domains may be more resistant to abrasion or more difficult to abrade). In this way, the second domains may be more easily abraded than the first domains but may still cover the substrate. The second domains may contribute some of the same advantages as the channels described above but may reduce flow of gas over the tip of the blade or knife.

The first effective abradability and the second effective abradability may be a function of, for example, the chemistry of the first and second domains, the porosity of the first and second domains, the application technique for the first and second domains, or the like. In some examples, the first and second domains are formed from the same material (i.e., have the same chemistry), but have different levels of porosity. For example, the second domains may have a greater volume percentage of porosity, where porosity is a ratio of free space within a domain to a total volume of the domain (including both free space and space occupied by material). Porosity may be measured using, for example, microscopy, porosimmetry, or the like.

In some examples, instead of or in addition to different amounts of porosity, the first domains and the second domains may include different materials. For example, the material from which the second domains are formed may have a modulus lower than a modulus of the material from which the first domains are formed. The first domains and second domains may include any suitable material, including any of the materials described above for use in non-continuous abradable coating 14. For example, the first domains and second domains may include materials such as aluminum nitride, aluminum diboride, boron carbide, aluminum oxide, mullite, zirconium oxide, carbon, silicon carbide, silicon nitride, silicon metal, silicon alloy, a transition metal nitride, a transition metal boride, a rare earth oxide, a rare earth silicate, zirconium oxide, a stabilized zirconium oxide (for example, yttria-stabilized zirconia), a stabilized hafnium oxide (for example, yttria-stabilized hafnia), barium-strontium-aluminum silicate, or mixtures and combinations thereof.

The first and second domains may define any suitable shapes. For example, the first and second domains may define shapes as shown in FIGS. 2-6. In some examples, the first domains may constitute a majority (e.g., greater than 50% by area) of the surface of the abradable coating, and the second domains may constitute a remainder of the surface of the abradable coating. In other examples, the second domains may constitute a majority of the surface of the abradable coating, and the first domains may constitute a remainder of the surface of the abradable coating.

For example, similar to non-continuous abradable coating 30 shown in FIG. 2, an abradable coating may include a plurality of first domains 32 and a continuous second domain 34, or ma include a plurality of second domains 32 and a continuous first domain 34. Similar to non-continuous abradable coating 40 shown in FIG. 2, an abradable coating may include a plurality of first domains 42 alternating with a plurality of second domains 44. The first domains, the second domains, or both, may include any one or more of a variety of shapes, such as solid honeycombs, hollow honeycombs, solid polygons, hollow polygons, lines, zig-zags, sinusoidal shapes, triangular grids, square grids, rectangular grids, or the like.

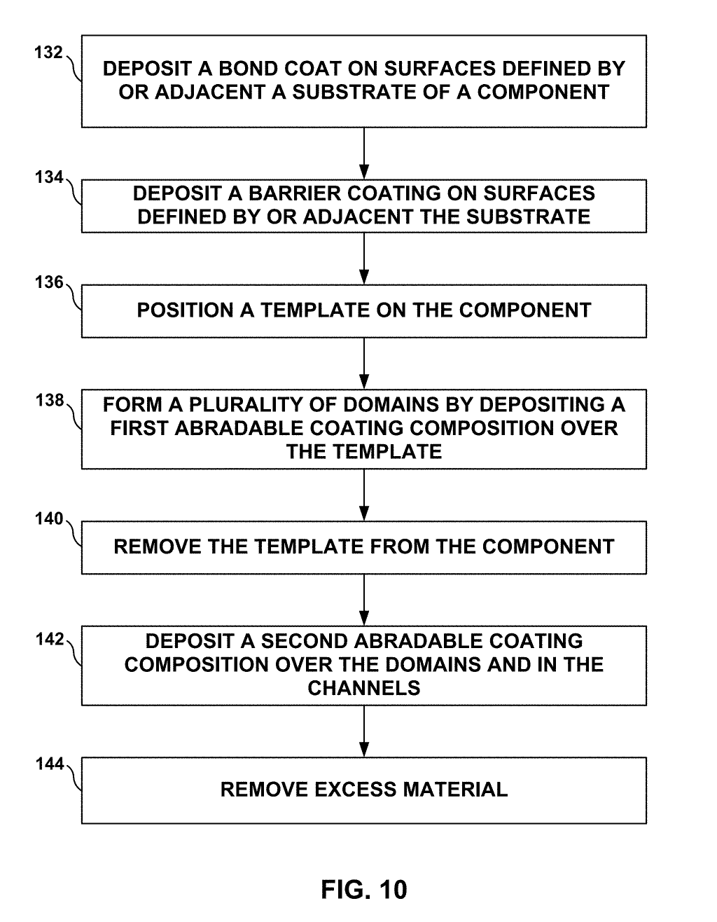

An abradable coating including first domains and second domains may be formed using any suitable technique. For example, as shown in FIG. 10, the technique may begin like the technique of FIG. 8 with the optional deposition of a bond coat on surfaces defined by or adjacent to a substrate of a component (132). This step may be similar to or substantially the same as step (102) of FIG. 8. Similarly, an optional barrier coating may be deposited on surface defined by or adjacent to the substrate (134), like step (104) of FIG. 8. Like step (106) of FIG. 8, a template may be positioned on the component (136)

Once the template has been positioned on the component (136), a plurality of domains may be formed on the component by depositing an abradable coating composition over the template (138). This may be like step (108) of FIG. 8, and may be accomplished using any suitable technique, including thermal spraying, slurry deposition, or the like. Step (138) may optionally include a heat treatment, as described above with respect to step (108) of FIG. 8. The plurality of domains may be first domains having a first, lower effective abradability or second domains having a second, higher effective abradability.

Once the plurality of domains have been formed on the component (138), the template may be removed from the surface of the component (140). The template may be removed by peeling or pulling the template from the substrate, may be removed (e.g., burned off) during the optional heat treatment step, or the like. Removal of the template leaves the plurality of domains separated by channels.

The technique of FIG. 10 then includes depositing a second abradable coating composition over the plurality of domains and in the channels (142). The second abradable coating composition may be the same or different than the first abradable coating composition. For example, the second abradable coating composition may include the same matrix composition as the first abradable coating composition or a different matrix composition than the first abradable coating composition. As another example, the second abradable coating composition may include more or less fugitive material than the first abradable coating composition to achieve a higher or lower porosity, respectively, than the plurality of domains formed from the first abradable coating composition.

Depositing the second abradable coating composition over the plurality of domains and in the channels (142) may be accomplished using any of the technique described herein, including, for example, thermal spraying, slurry deposition, or the like. In some examples, the second abradable coating composition may be deposited using the same technique as the first abradable coating composition. In other examples, the second abradable coating composition may be deposited using a different technique than the first abradable coating composition.

The second abradable coating composition may be deposited to a depth that at least fills the full depth of the channels. In examples in which the second abradable coating composition is deposited using thermal spraying, the second abradable coating composition may cover the plurality of domains deposited from the first abradable coating composition to a substantially similar depth as the depth of the second abradable coating composition in the channels. In examples in which the second abradable coating composition is deposited using slurry deposition, the slurry may be deposited to be substantially level with the outer surface of the plurality of domains deposited from the first abradable coating composition or may be deposited to cover the outer surface of the plurality of domains to a predetermined depth.

Depositing the second abradable coating composition over the plurality of domains and in the channels (142) may optionally include a heat treatment step. In some examples, the technique of FIG. 10 includes a single heat treatment step as part of depositing the second abradable coating composition over the plurality of domains and in the channels (142), which exposes both the plurality of domains deposited from the first abradable coating composition and the domain(s) deposited form the second abradable coating composition to a simultaneous heat treatment. In other examples, the technique of FIG. 10 may include a heat treatment step as part of forming a plurality of domains by depositing an abradable coating composition over the template (138) and depositing the second abradable coating composition over the plurality of domains and in the channels (142). In examples in which the technique of FIG. 10 includes two heat treatment steps, the heat treatment steps may be the same or different. The optional heat treatment step as part of depositing the second abradable coating composition over the plurality of domains and in the channels (142) may have parameters selected from those described above with respect to the heat treatment of FIG. 8.

In some examples, such as when the second abradable coating composition is deposited using thermal spraying, excess material deposited as part of depositing the second abradable coating composition over the plurality of domains and in the channels (142) may be removed (144). The excess material may be removed using any suitable technique, including, for example, machining. In some examples, the excess material is only excess material deposited as part of depositing the second abradable coating composition and is only located over the plurality of domains. In other examples, an upper portion of at least some of the plurality of domains deposited from the first abradable coating material is also removed to make the outer surface of the abradable coating substantially level between the first domains and the second domains.

Clause 1: A component comprising: a substrate; and a non-continuous abradable coating on the substrate, wherein the non-continuous abradable coating comprises a plurality of respective physical segments, wherein each respective segment is separated from an adjacent respective physical segment by a respective channel, wherein the channel extends through an entire thickness of the non-continuous abradable coating, and wherein the channel does not extend through any part of a layer underlying the non-continuous abradable coating.

Clause 2: The component of clause 1, wherein the component comprises a substantially cylindrical blade track, and wherein the non-continuous abradable coating is on a cylindrical surface defined by the substantially cylindrical blade track.

Clause 3: The component of clause 1 or clause 2, wherein: the non-continuous abradable coating defines a honeycomb pattern; the plurality of respective physical segments comprise respective cells of the honeycomb pattern; and the channel defines the border between respective cells of the honeycomb pattern.

Clause 4: The component of clause 3, wherein the channel comprises a plurality of channels, wherein each channel of the plurality of channels is substantially parallel to an axis of the substantially cylindrical blade track.

Clause 5: The component of clause 3, wherein the channel comprises a plurality of channels, wherein each channel of the plurality of channels is oriented canted with respect to an axis of the substantially cylindrical blade track.

Clause 6: The component of clause 5, wherein a direction of the cant of the plurality of channels is opposite to a swirl of fluid traveling along a surface of the non-continuous abradable coating.

Clause 7: The component of any one of clauses 1 to 6, wherein the channel defines at least one of a sinusoid, a zig-zag, or a line.

Clause 8: The component of any one of clause 1 to 7, wherein the respective physical segments exhibit a porosity between about 10 vol. % and about 40 vol. %.

Clause 9: The component of any one of clauses 1 to 8, wherein the substrate comprises a ceramic matrix composite.

Clause 10: The component of any one of clauses 1 to 9, wherein the non-continuous abradable coating comprises at least one of aluminum nitride, aluminum diboride, boron carbide, aluminum oxide, mullite, zirconium oxide, carbon, silicon metal, silicon alloy, silicon carbide, silicon nitride, a transition metal nitride, a transition metal boride, a rare earth oxide, a rare earth silicate, a stabilized zirconium oxide, a stabilized hafnium oxide, or barium-strontium-aluminum silicate.

Clause 11: A system comprising: the component of any one of claims 1 to 10; and a rotating component configured to contact an abradable surface defined by the non-continuous abradable coating with a portion of the rotating component.

Clause 12: A method comprising: positioning a template on a surface of a component; and thermal spraying an abradable coating composition on the component, wherein the template causes the abradable coating composition to deposit on the component as a non-continuous abradable coating comprising a plurality of respective physical segments separated by the template, and wherein the template causes the abradable coating composition to not be deposited on portions of the surface of the component under the template.

Clause 18: The method of clause 17, wherein the abradable coating composition comprises at least one of aluminum nitride, aluminum diboride, boron carbide, aluminum oxide, mullite, zirconium oxide, carbon, silicon metal, silicon alloy, silicon carbide, silicon nitride, a transition metal nitride, a transition metal boride, a rare earth oxide, a rare earth silicate, a stabilized zirconium oxide, a stabilized hafnium oxide, or barium-strontium-aluminum silicate.

Clause 19: The method of clause 17 or 18, wherein: the abradable coating composition comprises a porosity-creating additive; the porosity-creating additive comprises one or more of graphite, hexagonal boron nitride, a polymer, a polyester; and the concentration of the porosity-creating additive in the abradable coating composition is controlled to cause the respective physical segments to exhibit a porosity between about 10 vol. % and about 40 vol. %.

Clause 20: The method of any one of clauses 17 to 19, wherein the high-performance component comprises a substantially cylindrical blade track, and wherein the non-continuous abradable track is on a cylindrical surface defined by the substantially cylindrical blade track.

Clause 21: A component comprising: a substrate; and an abradable coating on the substrate, wherein the abradable coating comprises a plurality of first domains and at least one second domain, wherein the plurality of first domains exhibit a first effective abradability, wherein the at least one second domain exhibits a second effective abradability that is different from the first effective abradability, and wherein each first domain of the plurality of first domains is separated from adjacent first domains by the at least one second domain.

Clause 22: The component of clause 21, wherein the first effective abradability is less than the second effective abradability.

Clause 23: The component of clause 21, wherein the first effective abradability is greater than the second effective abradability.

Clause 24: The component of any one of clauses 21 to 23, wherein the plurality of first domains cover a majority of the substrate.

Clause 25: The component of any one of clauses 21 to 23, wherein the at least one second domain covers a majority of the substrate.

Clause 26: The component of any one of clauses 21 to 25, wherein the at least one second domain comprises a plurality of second domains.

Clause 27: The component of any one of clauses 21 to 26, wherein the plurality of first domains and the at least one second domain comprise the same chemistry.

Clause 28: The component of any one of clauses 21 to 26, wherein the plurality of first domains and the at least one second domain comprise different chemistry.

Clause 29: The component of any one of clauses 21 to 28, wherein the plurality of first domains and the at least one second domain comprise at least one of aluminum nitride, aluminum diboride, boron carbide, aluminum oxide, mullite, zirconium oxide, carbon, silicon metal, silicon alloy, silicon carbide, silicon nitride, a transition metal nitride, a transition metal boride, a rare earth oxide, a rare earth silicate, a stabilized zirconium oxide, a stabilized hafnium oxide, or barium-strontium-aluminum silicate.

Clause 30: A method comprising: positioning a template on a surface of a component; and depositing a first abradable coating composition on the component, wherein the template causes the abradable coating composition to deposit on the component as a plurality of first domains separated by the template, and wherein the template causes the abradable coating composition to not be deposited on portions of the surface of the component under the template; removing the template from the component to expose channels between the plurality of first domains; and depositing a second abradable coating composition over the plurality of domains and in the channels.

Clause 31: The method of clause 30, further comprising removing excess second abradable coating composition from surfaces of the plurality of first domains.

Clause 32: The method of clause 30 or 31, wherein depositing the first abradable coating composition on the component comprises thermally spraying the first abradable coating composition on the component.

Clause 33: The method of clause 30 or 31, wherein depositing the first abradable coating composition on the component comprises slurry depositing the first abradable coating composition on the component.

Clause 34: The method of any one of clauses 30 to 33, wherein depositing the second abradable coating composition over the plurality of domains and in the channels comprises thermally spraying the second abradable coating composition over the plurality of domains and in the channels.

Clause 35: The method of any one of clauses 30 to 33, wherein depositing the second abradable coating composition over the plurality of domains and in the channels comprises slurry depositing the second abradable coating composition over the plurality of domains and in the channels.

### Examples

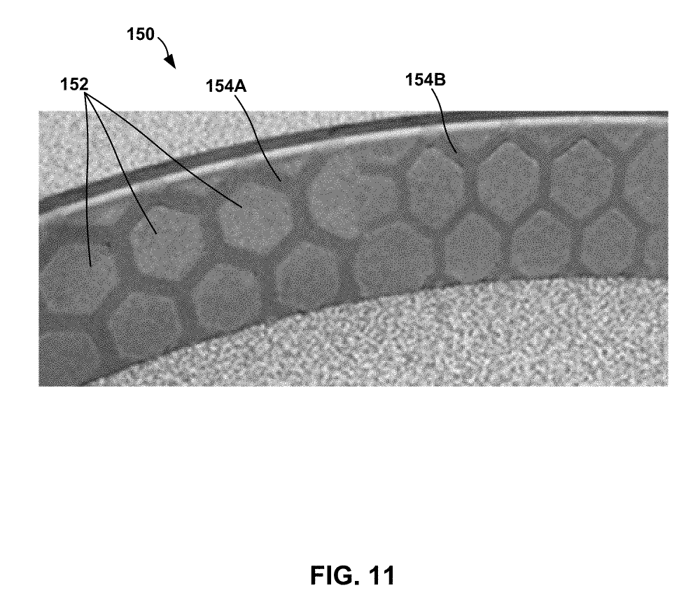

FIG. 11 is a photograph of an example component 150 including an abradable coating 152 that includes a plurality of first domains 154, and second domain 156A and 156B. Abradable coating 152 was formed by thermal spraying a first abradable coating composition over two templates (one in the shape of second domain 156A and one in the shape of second domain 156B) to form the plurality of first domains 154. The molds were then removed and a second abradable coating composition was thermally sprayed over the plurality of first domains 154 to fill the channels left by the removal of the templates. The as-sprayed coating was then machined to remove excess second abradable coating composition and form abradable coating 152 shown in FIG. 11.

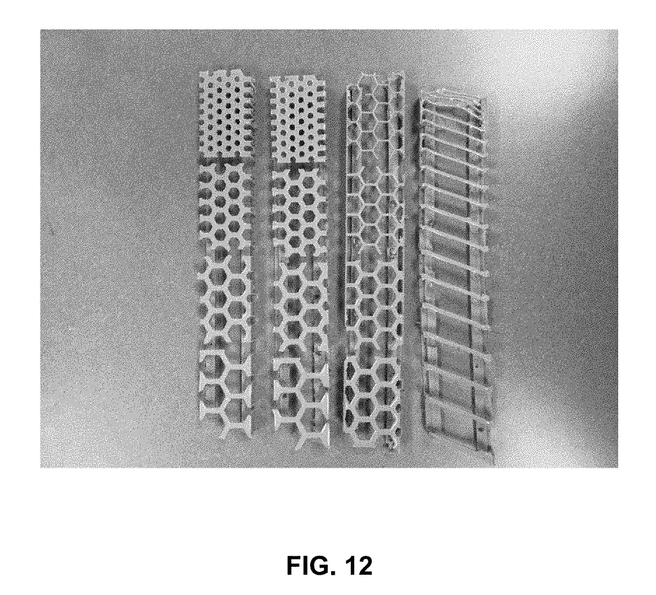

FIG. 12 is a photograph of example templates formed from a flexible polymer.

Various examples have been described. These and other examples are within the scope of the following claims.

What is claimed is:

1. A component comprising:
a substrate; and
a non-continuous abradable coating on the substrate, wherein the non-continuous abradable coating comprises a plurality of respective physical segments, wherein each respective segment is separated from an adjacent respective physical segment by a respective channel, wherein the channel extends through an entire thickness of the non-continuous abradable coating, and wherein the channel does not extend through any part of a layer underlying the non-continuous abradable coating.

2. The component of claim 1, wherein the component comprises a substantially cylindrical blade track, and wherein the non-continuous abradable coating is on a cylindrical surface defined by the substantially cylindrical blade track.

3. The component of claim 1, wherein:
the non-continuous abradable coating defines a honeycomb pattern;
the plurality of respective physical segments comprise respective cells of the honeycomb pattern; and
the channel defines the border between respective cells of the honeycomb pattern.

4. The component of claim 3, wherein the channel comprises a plurality of channels, wherein each channel of the plurality of channels is substantially parallel to an axis of the substantially cylindrical blade track.

5. The component of claim 3, wherein the channel comprises a plurality of channels, wherein each channel of the plurality of channels is oriented canted with respect to an axis of the substantially cylindrical blade track.

6. The component of claim 5, wherein a direction of the cant of the plurality of channels is opposite to a swirl of fluid traveling along a surface of the non-continuous abradable coating.

7. The component of claim 1, wherein the channel defines at least one of a sinusoid, a zig-zag, or a line.

8. The component of claim 1, wherein the respective physical segments exhibit a porosity between about 10 vol. % and about 40 vol. %.

9. The component of claim 1, wherein the substrate comprises a ceramic matrix composite.

10. The component of claim 1, wherein the non-continuous abradable coating comprises at least one of aluminum nitride, aluminum diboride, boron carbide, aluminum oxide, mullite, zirconium oxide, carbon, silicon metal, silicon alloy, silicon carbide, silicon nitride, a transition metal nitride, a transition metal boride, a rare earth oxide, a rare earth silicate, a stabilized zirconium oxide, a stabilized hafnium oxide, or barium-strontium-aluminum silicate.

11. A system comprising:
a component comprising:
a substrate; and
a non-continuous abradable coating on the substrate, wherein the non-continuous abradable coating comprises a plurality of respective physical segments, wherein each respective segment is separated from an adjacent respective physical segment by a respective channel, wherein the channel extends through an entire thickness of the non-continuous abradable coating, and wherein the channel does not extend through any part of a layer underlying the non-continuous abradable coating; and
a rotating component configured to contact an abradable surface defined by the non-continuous abradable coating with a portion of the rotating component.

12. The system of claim 11, wherein the component comprises a substantially cylindrical blade track, and wherein the non-continuous abradable coating is on a cylindrical surface defined by the substantially cylindrical blade track.

13. The system of claim 11, wherein:
the non-continuous abradable coating defines a honeycomb pattern;
the plurality of respective physical segments comprise respective cells of the honeycomb pattern; and
the channel defines the border between respective cells of the honeycomb pattern.

14. The system of claim 13, wherein the channel comprises a plurality of channels, wherein each channel of the plurality of channels is substantially parallel to an axis of the substantially cylindrical blade track.

15. The system of claim 13, wherein the channel comprises a plurality of channels, wherein each channel of the plurality of channels is oriented canted with respect to an axis of the substantially cylindrical blade track.

16. The system of claim 11, wherein the channel defines at least one of a sinusoid, a zig-zag, or a line.

17. A method comprising:
positioning a template on a surface of a component; and
depositing an abradable coating composition on the component, wherein the template causes the abradable coating composition to deposit on the component as a non-continuous abradable coating comprising a plurality of respective physical segments separated by the template, and wherein the template causes the abradable coating composition to not be deposited on portions of the surface of the component under the template.

18. The method of claim 17, wherein the abradable coating composition comprises at least one of aluminum nitride, aluminum diboride, boron carbide, aluminum oxide, mullite, zirconium oxide, carbon, silicon metal, silicon alloy, silicon carbide, silicon nitride, a transition metal nitride, a transition metal boride, a rare earth oxide, a rare earth silicate, a stabilized zirconium oxide, a stabilized hafnium oxide, or barium-strontium-aluminum silicate.

19. The method of claim 17, wherein:
the abradable coating composition comprises a porosity-creating additive;
the porosity-creating additive comprises one or more of graphite, hexagonal boron nitride, a polymer, a polyester; and
the concentration of the porosity-creating additive in the abradable coating composition is controlled to cause the respective physical segments to exhibit a porosity between about 10 vol. % and about 40 vol. %.

20. The method of claim 17, wherein the high-performance component comprises a substantially cylindrical blade track, and wherein the non-continuous abradable track is on a cylindrical surface defined by the substantially cylindrical blade track.
